(19) United States
(12) Patent Application Publication
(10) Pub. No.: US 2008/0271957 A1
(43) Pub. Date: Nov. 6, 2008

(54) Elevator Door Coupler

(76) Inventors: Bryan R. Siewert, Westbrook, CT (US); Xiaodong Luo, South Windsor, CT (US); Pei-Yuan Peng, Manchester, CT (US); Muhidin A. Lelic, Manchester, CT (US); Joseph Zacchio, Wethersfield, CT (US); Mark E. Renzulli, Tolland, CT (US); Michael Tracey, Cromwell, CT (US); Thomas Malone, Avon, CT (US)

Correspondence Address: CARLSON GASKEY & OLDS, 400 W MAPLE STE 350, BIRMINGHAM, MI, 48009, US

(21) Appl. No.: 11/570,890

(22) PCT Filed: Jun. 21, 2004
(86) PCT No.: PCT/US2004/019530

§ 371 Date: Dec. 19, 2006

(51) Int. Cl. B66B 13/14

(52) U.S. Cl. 187/319

(57) ABSTRACT

An elevator door assembly (20) includes a single vane member (32) associated with a hoistway door (26). A magnetic device (36) on a car door (24) establishes a magnetic coupling with the vane member (32) to cause the hoistway door (26) to move with the car door (24) in at least two opposite directions. In a disclosed embodiment, a control (38) selectively powers the magnetic device (36), which comprises an electromagnet.

### FIELD OF THE INVENTION

This invention generally relates to elevator systems. More particularly, this invention relates to a door coupler arrangement for use in elevator systems.

### DESCRIPTION OF THE RELATED ART

Elevators typically include a car that moves vertically through a hoistway between different levels of a building. At each level or landing, a set of hoistway doors are arranged to close off the hoistway when the elevator car is not at that landing. The hoistway doors open with doors on the car to allow access to or from the elevator car when it is at the landing. It is necessary to have the hoistway doors coupled appropriately with the car doors to open or close them.

Conventional arrangements include a door interlock that typically integrates several functions into a single device. The interlocks lock the hoistway doors, sense that the hoistway doors are locked and couple the hoistway doors to the car doors for opening purposes. While such integration of multiple functions provides lower material costs, there are significant design challenges presented by conventional arrangements. For example, the locking and sensing functions must be precise to satisfy codes. The coupling function, on the other hand, requires a significant amount of tolerance to accommodate variations in the position of the car doors relative to the hoistway doors. While these functions are typically integrated into a single device, their design implications are usually competing with each other.

Conventional door couplers include a vane on the car door and a pair of rollers on a hoistway door. The vane must be received between the rollers so that the hoistway door moves with the car door in two opposing directions (i.e., opening and closing). Common problems associated with such conventional arrangements is that the alignment between the car door vane and the hoistway door rollers must be precisely controlled. This introduces labor and expense during the installation process. Further, any future misalignment results in maintenance request or call backs.

It is believed that elevator door system components account for approximately 50% of elevator maintenance requests and 30% of callbacks. Almost half of the callbacks due to a door system malfunction are related to one of the interlock functions.

Additionally, with conventional arrangements debris build up on the door track and static pressure from the stack effect tend to impede the hoistway doors from fully closing. It is desirable to have hoistway doors driven completely closed by the car doors to avoid call back and maintenance problems. With conventional designs, driving the hoistway door closed causes delays in the door opening and closing times, which can appear to be an inconvenience to passengers.

There is a need in the industry for an improved arrangement that provides a reliable coupling between the car doors and hoistway doors, yet avoids the complexities of conventional arrangements and provides a more reliable arrangement that has reduced need for maintenance. This invention addresses that need with a unique elevator door coupler.

### SUMMARY OF THE INVENTION

An exemplary elevator door coupler embodiment of this invention includes a vane member that is adapted to be supported on a hoistway door. A magnetic device is adapted to be supported on an elevator car door in a position to contact the vane member when the magnetic device moves in a first direction. A magnetic coupling between the magnetic device and the vane member causes the vane member to move in a second, opposite direction with the magnetic device.

Utilizing a single vane member on a hoistway door provides a simplified arrangement compared to conventional techniques.

In one example, the magnetic device is an electromagnet that is selectively powered for maintaining the vane member in a coupled relationship so that the hoistway and car doors move together. In one example, physical contact between the magnetic device and the vane member allows the magnetic device to urge the vane member and the hoistway door into an open position. As the car door returns to a closed position, the magnetic device ensures that the vane member follows and the hoistway door is moved toward the closed position as the car door moves toward the closed position.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 schematically illustrates selected portions of an elevator system incorporating a door assembly designed according to an embodiment of this invention.

FIG. 2 schematically illustrates cooperation between a vane member and a magnetic device of an example embodiment of this invention in a first relative door position.

FIG. 3 shows the embodiment of FIG. 2 in a second operation position.

FIG. 4 shows the embodiment of FIG. 2 in another operating position.

FIG. 5 shows the embodiment of FIG. 2 in still another operating position.

### DETAILED DESCRIPTION OF THE PREFERRED EMBODIMENTS

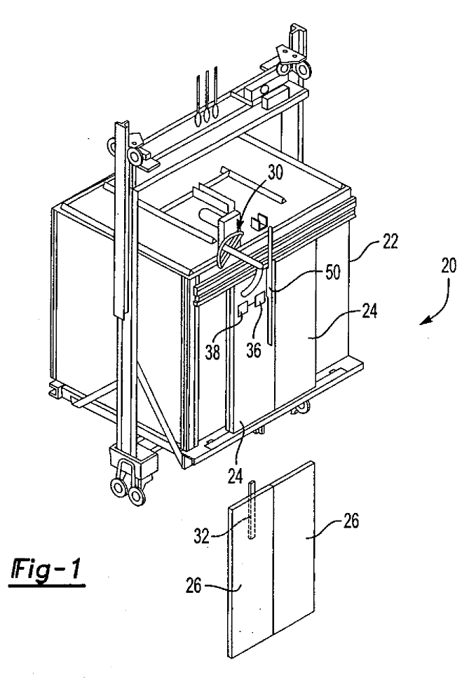

FIG. 1 schematically shows an elevator door assembly 20 that includes a unique door coupler. An elevator car 22 has car doors 24 that are supported for movement with the car through a hoistway, for example. The car doors 24 become aligned with hoistway doors 26 at a landing, for example, when the car 22 reaches an appropriate vertical position. The disclosed example door coupler facilitates better door operation and avoids the difficulties with alignment presented by conventional designs.

The example door coupler includes a vane member 32 supported on at least one of the hoistway doors 26. In the example embodiment, a single vane member 32 is associated with a corresponding door. In this example, the car doors 24 are linked in a known manner such that movement of one of the doors 24 as caused by a door operator 30, for example, results in movement of the other door 24. Similarly, the hoistway doors 26 in this example are linked in a manner such that they move at the same time. In another example, a single vane member is associated with each of the doors.

As the door operator 30 causes the car doors 24 to move toward an open position, a magnetic device 36 moves into contact with the vane member 32 for causing the hoistway doors 26 to open, also. When it is time to close the doors, the magnetic device 36 is magnetically coupled with the vane member 32 for moving together so that the hoistway doors 26 move toward a closed position along with the elevator car doors 24.

In the example of FIG. 1, the magnetic device 36 comprises an electromagnet. A control 38 selectively provides current to the electromagnet for establishing a magnetic coupling between the vane member 32 and the magnetic device 36. The magnetic device 36 and the control 38 are supported on the car 22 for movement with the car throughout the hoistway. The power for supplying current to the magnetic device 36 in one example is derived from the power already available on the elevator car 22. In another example, a dedicated power source such as a battery is provided.

In the disclosed example, the control 38 activates or powers the magnetic device 36 responsive to at least one condition being satisfied. In one example, the control 38 receives information (from a conventional sensor, for example) regarding physical contact between the magnetic device 36 and the vane member 32. Responsive to such contact, the control 38 activates or energizes the magnetic device 36 to maintain an appropriate coupling between it and the vane member 32.

In another example, the control detects motor torque of the door operator 30 as an indication that the magnetic device 36 has contacted and is effectively pushing the vane 32 and the hoistway door 26. Another embodiment senses a change in reluctance associated with a DC motor of the door operator 30.

Turning off an electromagnet in the magnetic device in one example is timed to occur precisely when the doors are closed. In one example, the electromagnet current is profiled downward to release the magnetic coupling at the end of the door movement and the fully closed position.

In another example, the control 38 energizes the magnetic device 36 whenever the car 22 reaches an appropriate landing responding to a call, for example. In one example, the magnetic device 36 is selectively powered at various stages of a door moving cycle. For example, the power is turned off in a fully opened position to save energy and to avoid heat build-up. Other control strategies may provide enhanced noise or vibration control. Different control strategies for operating the magnetic device 36 are possible and those skilled in the art who have the benefit of this description will realize what works best for their situation. In one example, the magnetic device 36 is energized whenever the doors are accelerating or decelerating.

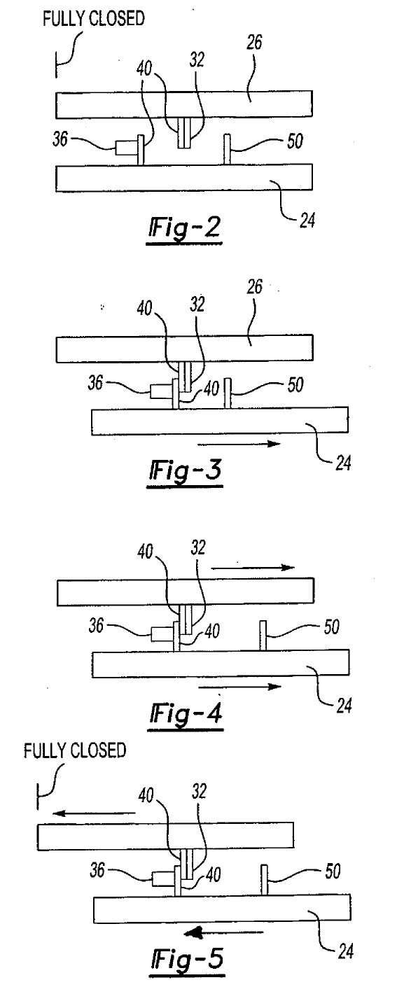

As best appreciated from FIGS. 2-5, interaction between a single vane member on the hoistway door 26 and the magnetic device 36 on the car door 24 allows for effective coupling between the doors for desired movement. Referring to FIG. 2, the hoistway door 26 and car door 24 (only one of each is shown) are in a fully closed position. As the car approaches the landing, the vane member 32 and the magnetic device 36 become vertically aligned so that facing surfaces on them can come into contact if either moves in a horizontal direction. In this example, a low friction material 40 is provided on the contacting surface of at least one of the vane member 32 or the magnetic device 36 to allow for some relative vertical movement between them while they are in physical contact with each other. Relative vertical movement can occur during loading or unloading at a landing, for example. The low friction material 40 also accommodates a situation where the vane member 32 and the magnetic device 36 are close enough to touch each other as the car is approaching a landing or leaving a landing, for example. In one example, a minimum 15 mm clearance is designed to prevent such contact.

As shown in FIG. 3, the car door 24 begins to open responsive to action of the door operator 30. Eventually, the magnetic device 36 contacts the vane member 32. At this point, further movement of the car door 24 toward an open position (i.e., to the right in the drawing) causes movement of the hoistway door 26 toward an open position, also. After reaching the fully opened position, shown in FIG. 4 for example, the magnetic device 36 keeps the vane member 32 coupled in a manner that facilitates both doors moving toward a closed position. As can be appreciated from the drawings, if the magnetic device 36 did not operate, movement of the car door 24 back toward the closed position (i.e., to the left in the drawing) would result in a separation from the vane member 32 and the hoistway door 26 would not necessarily follow the car door 24 toward the closed position.

In this example, the magnetic device 36 normally ensures an adequate coupling between it and the vane member 32 to draw the hoistway door 26 toward a closed position (i.e., to the left according to the drawing) as the car door 24 moves. In the illustrated example, the magnetic device 36 keeps the vane member 32 in physical contact with it throughout movement in either direction. The magnetic device 36 may only be powered for a magnetic coupling during a closing movement or during both an opening and closing movement, depending on the particular design of a particular embodiment.

The illustrated example includes a back up vane 50 that can contact the vane member 32 to push the hoistway door closed in the event that the magnetic device 36 were unable to remain coupled with the vane member 32 sufficiently to pull the hoistway door closed.

As can be appreciated from FIGS. 2 and 5, the position of the vane member 32 and the magnetic device 36 on the respective doors, when viewed in the width direction of the doors (i.e., right-to-left in the drawings), provides spacing between them when both doors are in a fully closed position. This spacing can provide additional clearance that allows for more tolerance with regard to vertical alignment of the door coupler components during installation and as the car 22 moves through the hoistway. This allows for decreased labor and expense during the installation process. One example embodiment has the further advantage that the vane member 32 and the magnetic device 36 are secured to their respective doors during the manufacturing process prior to arrival at the installation site. This eliminates labor during installation and introduces further economies.

As can be appreciated from FIG. 5, the position of the vane member 32 and the magnetic device 36 relative to their respective doors also provides an enhanced performance feature. Because the car door 24 moves toward an open position before the hoistway door 26, the hoistway door 26 approaches the closed position slightly ahead of the car door 24. As shown in FIG. 5, the magnetic device 36 maintains the coupling with the vane member 32 until at least the hoistway door 26 reaches the fully closed position. In this example embodiment, the door coupler facilitates having the movement of the car door 24 drive the hoistway door 26 to a fully closed position. This occurs in a reliable and efficient manner that does not introduce any delays to the closing operation, which enhances elevator system performance for passengers.

In one example, the vane member 32 at least partially comprises a ferromagnetic material such as steel so that the magnetic device 36 can maintain an appropriate coupling with the vane member 32 to cause desired movement of the hoistway door 26. Given this description, those skilled in the art will be able to select appropriate materials and component designs to meet the needs of their particular situation. Further, given this description those skilled in the art will be able to select appropriate performance characteristics of a magnetic device to achieve the desired coupling effect to meet the needs of their particular situation.

In the preceding examples, the magnetic device 36 is supported on a car door 24. In another example, the vane member 32 is supported on the car door 24 and the magnetic device 36 is supported on a hoistway door 26.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

1-20. (canceled)

21. An elevator door assembly, comprising:
at least one hoistway door;
at least one elevator car door;
a vane member supported for movement with one of the hoistway door or the elevator car door;
a magnetic device supported for movement with the other of the hoistway door or the elevator car door such that the magnetic device is always in a single position relative to the other of the hoistway door or the elevator car door where the magnetic device is positioned to contact the vane member when the car door moves in a first direction such that the car door and the hoistway door move together in the first direction and the vane member moves together with the magnetic device in a second, opposite direction such that the car door and the hoistway door move together in the second direction.

22. The assembly of claim 21, wherein the vane member is rigidly fixed to the hoistway door and the magnetic device is rigidly fixed to the car door.

23. The assembly of claim 21, wherein the magnetic device comprises an electromagnet.

24. The assembly of claim 23, including a control that selectively couples the electromagnet to a power source for selectively keeping the vane member moving together with the magnetic device.

25. The assembly of claim 24, wherein the control couples the electromagnet to the power source responsive to contact between the vane member and the magnetic device.

26. The assembly of claim 24, wherein the controller varies powering the electromagnet based on a position of at least one of the hoistway door or the car door.

27. The assembly of claim 24, wherein the controller uses a motor torque indication for controlling powering the electromagnet.

28. The assembly of claim 24, wherein the control couples the electromagnet to the power source responsive to the car reaching a selected position relative to the hoistway door.

29. The assembly of claim 24, wherein the control uncouples the electromagnet from the power source responsive to the hoistway door moving in the second direction into a fully closed position.

30. The assembly of claim 21, wherein the vane member is positioned along a width of the hoistway door and the magnetic device is positioned along a width of the car door such that the car door moves in the first direction a selected amount prior to the magnetic device contacting the vane member.

31. The assembly of claim 21, wherein the vane member is positioned along a width of the hoistway door and the magnetic device is positioned along a width of the car door such that the magnetic device and the vane member move together in a manner that the hoistway door reaches a fully closed position before the car door reaches a fully closed position when the doors move in the second direction.

32. The assembly of claim 21, including a low friction surface on at least one of the vane member or the magnetic device that facilitates relative longitudinal movement between the vane member and the magnetic device.

33. The assembly of claim 21, wherein the vane member is at least partially ferromagnetic.

34. The assembly of claim 21, wherein the magnetic device is supported in a position on a first side of the vane member and including a backup vane supported in a position on a second side of the vane member.

35. A method of coupling an elevator car door with a hoistway door, comprising:
providing a magnetic device on one of the hoistway door or the elevator car door;
providing a single vane member on the other of the hoistway door or the elevator car door;
driving the hoistway door in a first direction using at least physical contact between the magnetic device and the vane member;
driving the hoistway door in a second, opposite direction using a magnetic coupling between the magnetic device and the vane member; and
initiating a magnetic force of the magnetic device responsive to at least one of
i) motor torque of a door operator associated with the elevator car door,
ii) a change in reluctance associated with a door operator motor,
iii) an associated elevator car reaching a landing, or
iv) determining that the magnetic device has contacted the single vane member as a result of movement of at least the elevator car door in the first direction.

36. The method of claim 35, comprising
initiating the magnetic force after at least the elevator car door has moved in the first direction from a closed position toward an open position.

37. An elevator door assembly, comprising:
at least one hoistway door;
at least one elevator car door;
a vane member supported for movement with one of the hoistway door or the elevator car door;
a magnetic device supported for movement with the other of the hoistway door or the elevator car door; and
a control that selectively energizes the magnetic device to establish a magnetic coupling between the magnetic device and the vane member after at least the elevator car door has moved in a first direction from a closed position toward an open position.

38. The assembly of claim 37, wherein the magnetic device is positioned to contact the vane member as the car door moves in the first direction such that the car door and the hoistway door move together in the first direction and the magnetic coupling causes the vane member to move together with the magnetic device in a second, opposite direction such that the car door and the hoistway door move together in the second direction.

39. The assembly of claim 38, wherein the vane member is positioned along a width of the hoistway door and the magnetic device is positioned along a width of the car door such that the car door moves in the first direction a selected amount prior to the magnetic device contacting the vane member.

40. The assembly of claim 37, wherein the magnetic device is supported in a position on a first side of the vane member and including a backup vane supported in a position on a second side of the vane member.

41. An elevator door coupler, comprising:
a vane member adapted to be supported on one of a hoistway door or an elevator car door;
a magnetic device adapted to be supported on the other of the hoistway door or the elevator car door in a position to cause the vane member to move with the magnetic device when the magnetic device moves in a first direction and in a second, opposite direction; and
a low friction surface on at least one of the vane member or the magnetic device that facilitates relative movement between the vane member and the magnetic device in a third direction that is perpendicular to the first and second directions.
